(19) United States
(12) Patent Application Publication
(10) Pub. No.: US 2025/0121481 A1
(43) Pub. Date: Apr. 17, 2025

(54) TOOL ACCESSORY OR FEATURE OFFERING LONGITUDINAL COMPLIANCE AND/OR AXIAL COMPLIANCE, AND METHODS RELATING TO SAME

(71) Applicant: Scott J. Emmerich, Delavan, WI (US)

(72) Inventor: Scott J. Emmerich, Delavan, WI (US)

(21) Appl. No.: 18/917,689

(22) Filed: Oct. 16, 2024

Related U.S. Application Data
(60) Provisional application No. 63/590,773, filed on Oct. 16, 2023.

(51) Int. Cl. B25B 23/14; B25B 23/00; B25F 5/00; B25F 5/02

(52) U.S. Cl. CPC B25B 23/141; B25B 23/0035; B25F 5/001; B25F 5/021

(57) ABSTRACT

A tool accessory or feature for offering longitudinal compliance and/or axial compliance, and methods relating to same. The tool accessory or feature including an arbor for connecting the tool accessory or feature to a rotating tool; a drive shaft aligned with the arbor and capable of being rotated by the arbor, with the drive shaft having a longitudinal axis; and having either a longitudinal compliance structure or an axial compliance structure, or both. The longitudinal compliance structure being connected between the arbor and at least a portion of the drive shaft and capable of allowing the drive shaft to move along the longitudinal axis to give the drive shaft longitudinal compliance. The axial compliance structure connected between the arbor and drive shaft and capable of allowing the drive shaft to disengage from the arbor once a predetermined torque threshold has been reached to provide axial compliance.

### CROSS REFERENCE TO RELATED APPLICATIONS

This application claims the benefit of U.S. Provisional Patent Application No. 63/590,773, filed Oct. 16, 2023, which is incorporated herein by reference in its entirety.

### FIELD OF THE INVENTION

The present invention relates to a tool accessory or feature offering longitudinal compliance and/or axial compliance and methods relating to same. In some forms it may be implemented as a workpiece securing tool, a tool holder having same, a machine having same, an apparatus for using same and methods relating to all of the above.

### BACKGROUND OF THE INVENTION

Machinists use many different types of clamps for work holding applications in machining centers and elsewhere in their shops or workspaces. Manufacturers of such clamps produce products under such brands as MITEE BITE®, JERGENS®, CARR LANE® and WIXROYD®, to name a few. These clamps consist of a clamp body and a clamp screw. The clamps operate by tightening the screw which drives the clamp body into a portion of the workpiece to be held, thereby clamping the workpiece in position. A plurality of clamps are often used to secure the workpiece from multiple positions to ensure it is held steady throughout operation of the machining center. An example of a conventional machine shop clamp system 900 in operation is shown in FIGS. 9A-9C (this one using MITEE BITE® clamps), with FIG. 9A illustrating a plurality of clamps 902 positioned on a clamp fixture or bed 904, which are used to secure in place on the fixture 904 a workpiece 906 so that it can be machined via a tool. FIG. 9B illustrates one of the clamps 900 in perspective view, and FIG. 9C illustrates the clamp 902, fixture 904 and workpiece 906 in operational cross-section illustrating how the clamp 902 is cammed on one end 902a to tilt the knife edge 902b of the clamp 902 into engagement with workpiece 906 to compress or sandwich the workpiece 906 between the clamp 902 and a wall or structure 904a on the fixture 904. The clamp 902 being tightened or loosened via operation of a fastener, such as screw 902c.

Typically, the clamp screws 902c are manually tightened using a handheld hand tool, such as an Allen wrench (or hex key), or a handheld power tool, such as a drill driver with a hex bit. Thus, operators are required to tighten and loosen clamps and machined parts repeatedly throughout the manufacturing process. In one example, a workpiece such as metal stock is placed in large machining center so that tools held within the machining center can perform work on the workpiece (a process known as machining). The metal stock is held in place within the machining center via the clamps discussed above. It is important that the metal stock not move as most machining is done at very tight tolerances and, thus, requires precision. In an active machine shop, this means the process of tightening and loosening the workpieces to be machined happens over and over again and takes up a considerable amount of time in the machining process, thereby, reducing the efficiency of the shop and ability to maximize the amount of work done in same. Further, since this is typically done by hand (either with hand tools or hand-held power tools), there is also room for error when placing and clamping the workpieces or inconsistencies from one workpiece to another or from one machining job to another.

Other problems associated with conventional workpiece securing mechanisms (e.g., conventional clamping systems) is that it requires the use of additional hand tools or handheld power tools that are not otherwise used with the machining center. Further, such hand tools and/or handheld power tools do not make it easy to repeatedly secure workpieces from one workpiece to the next using the same parameters. In addition, there is a risk that some clamps are over tightened while others are under tightened, which can result in a less secure workpiece or a situation that may cause damage to the workpiece and/or the machining center or parts thereof.

Attempts have been made to address some of these issues by using automatic clamping equipment, but this entails additional equipment that is not otherwise used by the machining center and often requires the addition of a hydraulic or pneumatic robotic system placed near the opening of the machining center so that the robotic system can reach into the machining center to automatically actuate the clamps. The additional equipment required also clutters the work area and makes it less clean and efficient for a user to gain access to the portions of the machine center that they need to access from time to time. Further, this additional equipment may often introduce new problems to the process, such as under-tightening or overtightening the clamps which can cause damage to the workpiece and/or the machining center (e.g., causing excess torque on either, etc.).

Accordingly, it has been determined that a need exists for an improved workpiece securing tool, an improved tool holder having same, a machine having same, and methods relating to same which overcome the aforementioned limitations and which further provide capabilities, features and functions, not available in current fasteners and methods relating to same.

### SUMMARY OF PREFERRED EMBODIMENTS

Numerous features and concepts in accordance with the inventions disclosed herein are covered and/or aspects of the features and concepts. For example, in one form a tool is disclosed for actuating a workpiece securing fixture fastener. In another aspect a tool holder is disclosed for working with the tool mentioned immediately above. In still other forms, an entire machine is disclosed herein that utilizes the tool and tool holder disclosed herein. In addition to these embodiments, various additional embodiments focused on features of the above items are disclosed herein (e.g., dual clutches integrated with one another, adjustable torque limiting features, a one-way torque limiting feature, an alternate one-way (in the opposite direction) torque limiting feature, etc.). In addition to these, software and processor based apparatus and systems are disclosed, as are numerous methods related to all of the above. Further improvements to the clutching and compliance features of such a workpiece securing tool, tool holder having same, machine having same, and methods relating to same are also disclosed herein.

For example, in accordance with the above, in one form a workpiece securing tool is disclosed including an arbor for connecting to a spindle to rotate the arbor, a drive shaft having first and second ends located opposite one another, the drive shaft coupled to the arbor at the first end of the drive shaft via a torque limiting feature, and a bit driver coupled to the second end of the drive shaft and having a bit for engaging a fastener of a conventional workpiece securing system. In some forms, the torque limiting feature is a clutch that disengages the drive shaft from the arbor when a predetermined torque has been reached.

In other forms, a tool holder having such a tool is disclosed for installing the tool into conventional machine centers. In still other forms, a machine is disclosed containing such a tool and/or tool holder, such as for example, a machining center, drill, router, mill, grinder, and CNC machine, the machine having an automatic tool changer within which the tool and tool holder are stored until the tool and tool holder are to be connected to a spindle of the machine to tighten or loosen the fastener of the conventional workpiece securing system.

In other forms, a workpiece securing tool is disclosed having first and second clutches each operable separate from the other, with the first clutch disengaging a drive shaft from an arbor when a predetermined torque has been reached on the drive shaft as the drive shaft is rotated in a fastener tightening direction, and the second clutch disengaging the drive shaft from the arbor when a predetermined torque has been reached on the drive shaft as the drive shaft is rotated in a loosening direction.

In still other forms, an integrated clutch structure having a first clutch that operates as a primary clutch in a first circumstance and as a secondary clutch in a second circumstance different than the first. For example, in one form, the integrated clutch structure operates as a primary clutch in a first instance and as a secondary, backup clutch to the primary clutch in a second instance. In some forms, the secondary break away torque clutch is positioned between a primary torque clutch and an arbor to disengage a drive shaft when a torque is detected above a torque level at which the primary torque clutch is to operate.

In yet other embodiments, an axial compliant torque limiting fastener driver with adjustable torque settings is disclosed. Similarly, in other forms, a workpiece securing tool and tool holder assembly that are selectable from a plurality of tools in a tool carousel for a machine are disclosed, with the tool and tool holder assembly being operable once selected to actuate a fastener connected to a conventional workpiece securing system. In even more forms, a torque limiting device that limits torque in a plurality of manners to prevent damage to a conventional workpiece securing system clamp screw, a tool, a tool holder if present, and/or a machine utilizing the torque limiting device is disclosed.

In still other forms, the inventive concepts disclosed herein may form a tool accessory or feature offering axial compliance and longitudinal compliance for rotating tools (e.g., such as a spindle from a machine center, a milling machine, a cutting machine, a drill press, etc.). The tool accessory or feature preferably includes: an arbor for connecting the tool accessory or feature to a rotating tool; a drive shaft aligned with the arbor and capable of being rotated by the arbor and ultimately the spindle, with the drive shaft having a longitudinal axis extending therethrough; a longitudinal compliance structure connected between the arbor and at least a portion of the drive shaft and capable of allowing the drive shaft to move along the longitudinal axis to give the drive shaft longitudinal compliance; and an axial compliance structure connected between the arbor and drive shaft and capable of allowing the drive shaft to disengage from the arbor once a predetermined torque threshold has been reached to provide axial compliance to the tool accessory or feature.

Numerous other embodiments and related methods are also disclosed herein. These and other embodiments and methods of the invention will become apparent to one of ordinary skill in the art upon reading the detailed description of the invention that follows below.

### BRIEF DESCRIPTION OF THE DRAWINGS

The invention will be explained in exemplary embodiments with reference to drawings, in which:

FIG. 1 is a perspective view of a horizontal machining center including a workpiece securing tool in accordance with one aspect of the invention;

FIG. 2 is a perspective view of a vertical machining center including a workpiece securing tool in accordance with another aspect of the invention;

FIG. 3 is a perspective view of an alternate cutting machine including a workpiece securing tool in accordance with another aspect of the invention;

FIG. 4A is an exploded view of a workpiece securing tool and tool holder in accordance with another aspect of the invention, with this embodiment illustrating a dual clutch configuration;

FIG. 4B is a perspective view of the workpiece securing tool and tool holder of FIG. 4A not exploded.

FIG. 5 is an exploded view of just the workpiece securing apparatus of FIGS. 4A-4B.

FIG. 6 is an enlarged view of a clutch for the workpiece securing tool of FIG. 5 in accordance with one aspect of the invention;

FIG. 7 is an exploded view of the clutch of FIG. 6 exploded from the arbor of FIG. 5 in accordance with another aspect of the invention;

FIG. 8 is an exploded view of an alternate workpiece securing tool and tool holder in accordance with another aspect of the invention, with this embodiment illustrating only a single clutch configuration of the tool;

FIG. 9A is a perspective view of a conventional workpiece securing fixture;

FIG. 9B is a perspective view of a single fastener or clamp from the conventional workpiece securing fixture;

FIG. 9C is a partial cross-sectional view of the conventional workpiece securing fixture illustrating how the fastener or clamp engages the workpiece to secure the workpiece to the workpiece securing fixture;

FIG. 10 is a block diagram of an apparatus or system in accordance with one aspect of the invention;

FIG. 11 is a flow chart illustrating one exemplary routine that may be followed in connection with another aspect of the invention;

FIG. 12A is a side elevational view of an alternate workpiece securing tool having an alternate compliance arrangement in accordance with another aspect of the invention;

FIG. 12B is a similar side elevational view to that of FIG. 12A but with the outer arbor sleeve removed or made invisible so that internal workings of the tool can be seen;

FIG. 12C is a similar side elevational view to that of FIGS. 12A-B but with both the outer arbor extension and the clutch cup removed or made invisible so that more internal workings of the tool can be seen;

FIG. 12D is an exploded view of the workpiece securing tool of FIGS. 12A-12C;

FIG. 12E is a top plan view of the workpiece securing tool of FIGS. 12A-D;

FIG. 12F is a cross-sectional view of the workpiece securing tool of FIGS. 12A-E taken along line F-F as illustrated in FIG. 12E;

FIG. 12G is a cross-sectional view of the workpiece securing tool of FIGS. 12A-E taken along line G-G in FIG. 12E;

FIG. 12H is an enlarged view of the axial compliance feature of the workpiece securing tool of FIGS. 12A-E taken from the portion denoted by lines H-H in FIG. 12F showing the axial compliance feature disengaged from one another to allow for axial compliance;

FIG. 12I is an enlarged view of the longitudinal compliance feature or mating arrangement that allows for same in the workpiece securing tool of FIGS. 12A-E taken generally from the portion denoted by lines I-I in FIG. 12D but from a slightly different perspective view to show additional portions of the tool.

FIG. 13A is a perspective view of an axial compliance feature of the workpiece securing tool of FIGS. 12A-E (e.g., an integrated clutch) showing the axial compliance feature in its engaged position;

FIG. 13B is an exploded view of the axial compliance feature of FIG. 13A and FIGS. 12A-E; and

FIG. 13C is a perspective view of the axial compliance feature of FIG. 13A and FIGS. 12A-E shown when the axial compliance feature is disengaged to allow for axial compliance similar to that depicted in FIG. 12H.

While the invention will be described in connection with preferred embodiments, it will be understood that it is not intended to limit the invention to these embodiments. On the contrary, it is intended to cover all alternatives, modifications and equivalents as may be included within the spirit and scope of the invention as defined by the appended claims. Furthermore, skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF THE PREFERRED EMBODIMENT

Workpiece securing mechanisms or apparatus are used in a variety of applications across the spectrum of industries. Any facility having a workshop that performs basic cutting, shaping or finishing tasks typically has a need for such workpiece securing mechanisms or apparatus. In a typical workshop, a machinist will often spend much of their time securing a workpiece to a particular machine or machine bed so that work (e.g., cutting, shaping, finishing, etc.) can be performed on the workpiece. This task is often done by hand (e.g., hand tightening and loosening of clamps via a tool such as an Allen wrench or hex key) or by handheld power tools (e.g., drill drivers, etc.), resulting in fatiguing the worker and often times delaying production of actual work from the workshop (or at a minimum reducing the efficiency of the workshop). Not only are such tightening and loosening tasks with respect to the workpiece securing mechanism tedious, but they can have very negative implications if care is not used when doing this work each and every time. For example, an improperly secured workpiece can be damaged significantly if it is not secured solidly in place when a machine goes to perform work on same. Given that workpieces can often be expensive pieces of material and may already have been through other stages of the manufacturing process, damage to same can have extensive ramifications including loss of material, loss of time, workload backups and backlogs, etc.

As mentioned above, some attempts have been made to automate such tightening and loosening processes, but these typically entail adding additional equipment around the workspace (e.g., around the machining center or whatever tool is being used), thereby cluttering the workspace even further and making an already complicated process even that much more complicated. In most instances relating to machining centers, automated solutions for operating workpiece securing mechanisms entail the use of hydraulic or pneumatic robotic systems placed near the opening of the machining center so that the robotic system can reach into the machining center to automatically actuate the clamps. Besides cluttering the work space further, such systems can often introduce new problems to the process, such as under-tightening or overtightening the workpiece securing mechanisms (e.g., clamps) which can cause damage to the workpiece and/or the machining center (e.g., causing excess torque on either, etc.).

In one form, the present invention introduces a workpiece securing tool, such as an automated torque limiting fastener driver, that can be used by the machine to automate the workpiece securing process so that these tasks can be done more efficiently (e.g., faster, without cluttering the workspace, without the need for additional equipment beyond the machinery being used to perform work on the workpiece, etc.), and with more accuracy (e.g., repeatable performance over and over without discrepancy between each performance). While the features of the torque limiting fastener driver discussed herein can be implemented into a hand tool or a handheld power tool, a primary focus of this application is in applying same to machines, such as cutting, shaping or finishing machines (e.g., machining centers, lathes, mills, routers, drills, grinders, other CNC machines, etc.). In one preferred form, the torque limiting fastener driver is incorporated into a machining center tool such that it can be added to the automatic tool changer of the machining center (e.g., a rotating tool carrousel of the machining center) and merely selected from same when it is desired to operate the workpiece securing mechanism or apparatus used to secure a workpiece to the machining center or machining center bed. In this way, the workpiece securing tool is operable with the equipment contained in the machining center itself so that it is the machining center performing this task rather than requiring a user to manually perform the task with additional equipment or adding additional equipment such as a robotic assistant to perform this task. By doing so, the process can be further perfected such that it can be repeated over and over with greater efficiency and accuracy.

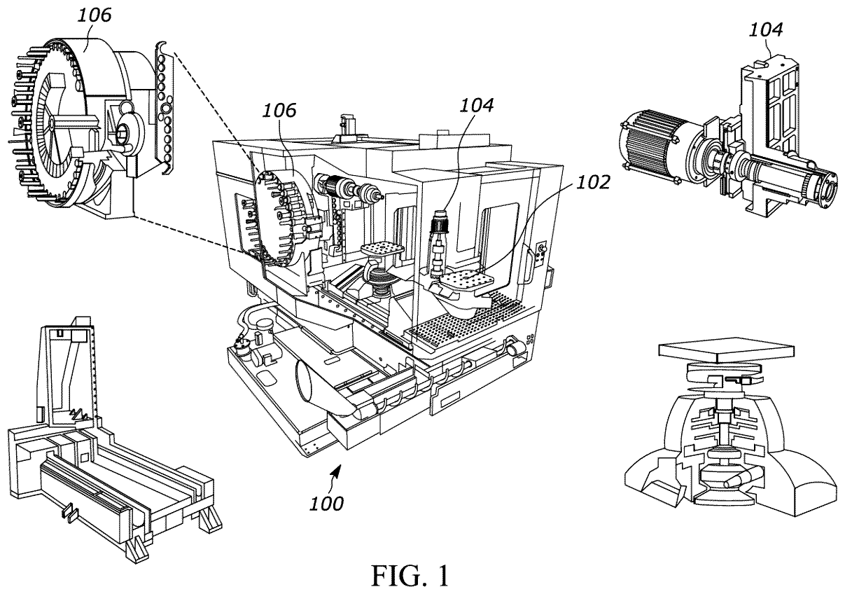

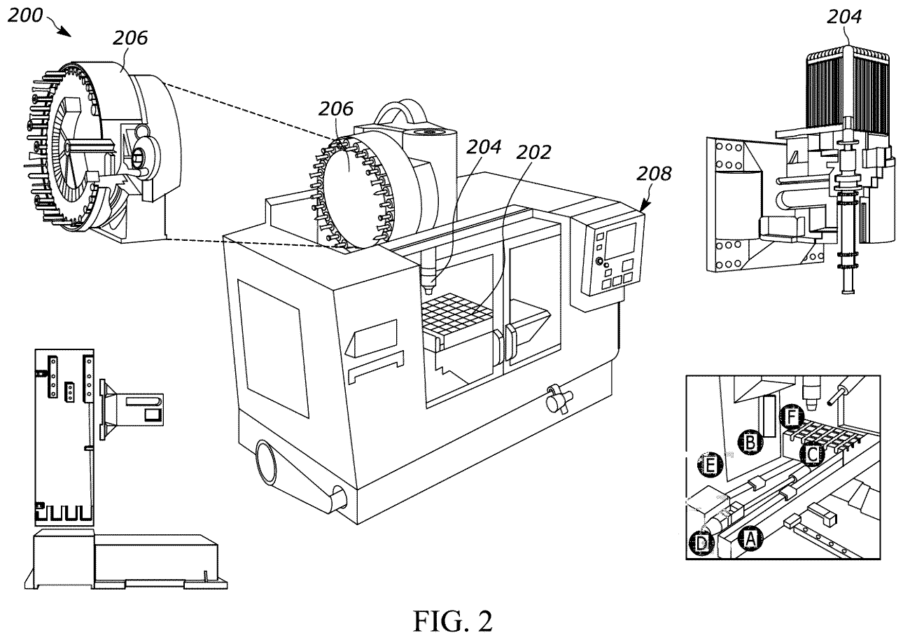

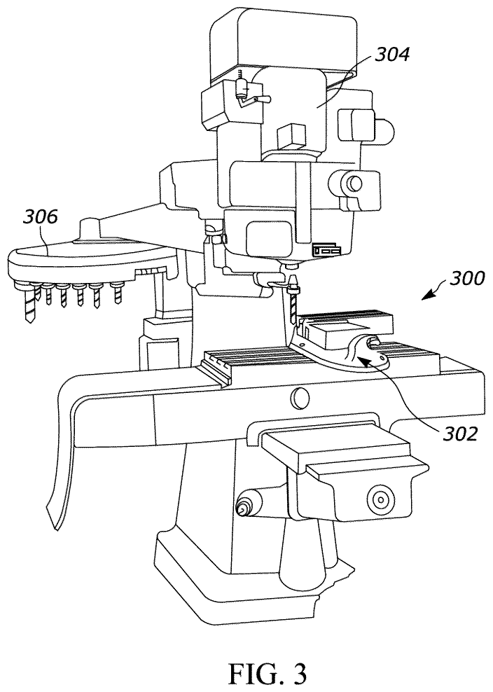

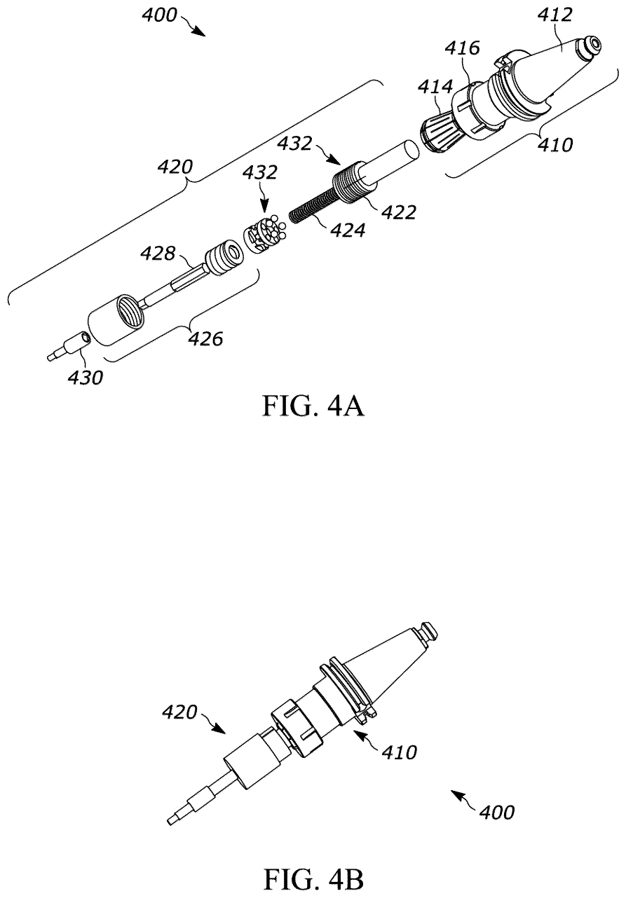

Turning now to the drawing figures, FIG. 1 illustrates a horizontal machining center that the workpiece securing mechanism or tool can be incorporated into. Alternatively, FIG. 2 illustrates a vertical machining center that the workpiece securing mechanism or tool can be incorporated into. Still further, FIG. 3 illustrates a milling machine that the workpiece securing mechanism or tool can be incorporated into. It should be understood that these are but a few of the various machines such a workpiece securing mechanism or tool can be utilized with and this invention is not intended to be limited to solely those machines illustrated in the figures. Before going into these exemplary machines in greater detail, we will start with a discussion of a preferred form of the workpiece securing mechanism or tool illustrated in FIGS. 4A, 4B and 5-7 as an automated torque limiting fastener driver and explain the details of that tool or apparatus prior to discussing how it can be implemented into various forms of machinery.

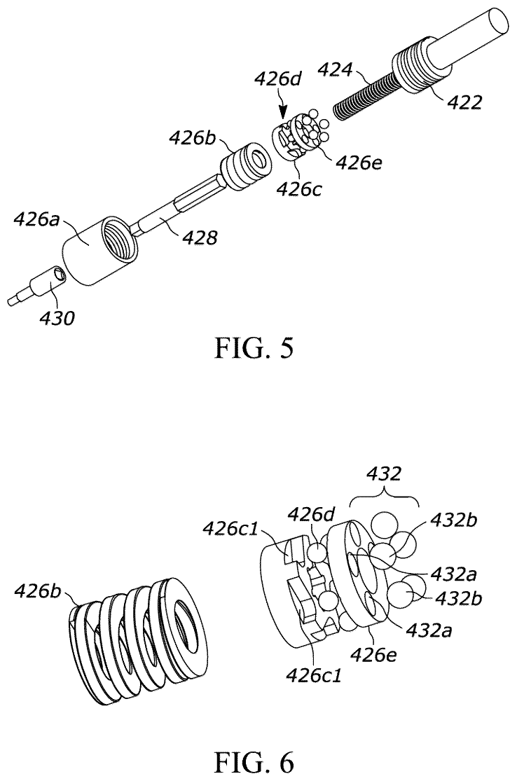

In FIGS. 4A and 4B a workpiece securing tool and tool holder 400 is illustrated, showing a conventional tool holder 410, such as for example a CAT40 tool holder, with the workpiece securing mechanism or tool 420 exploded therefrom. The tool 420 is shown in exploded view in FIG. 4A and in a perspective view in FIG. 4B of the fully assembled part installed in the tool holder 410. In FIG. 5, just the workpiece securing mechanism or tool 420 is illustrated in exploded fashion. As shown in FIG. 4A, the tool holder 410 includes a tool holder body 412, a tool holder collet 414 and clamping nut 416. Herein, the workpiece securing mechanism or tool 420 may be referred herein as a mechanism, tool, apparatus or assembly (the latter particularly when being referenced in combination with tool holder 410).

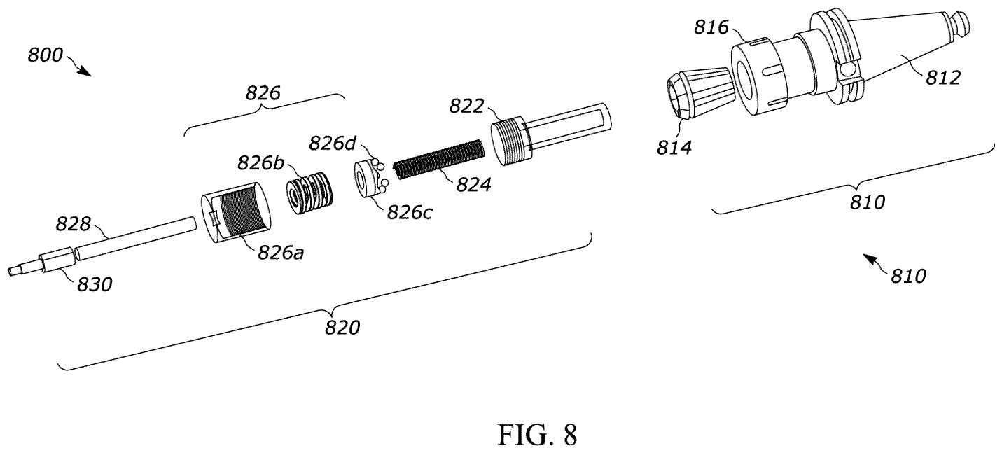

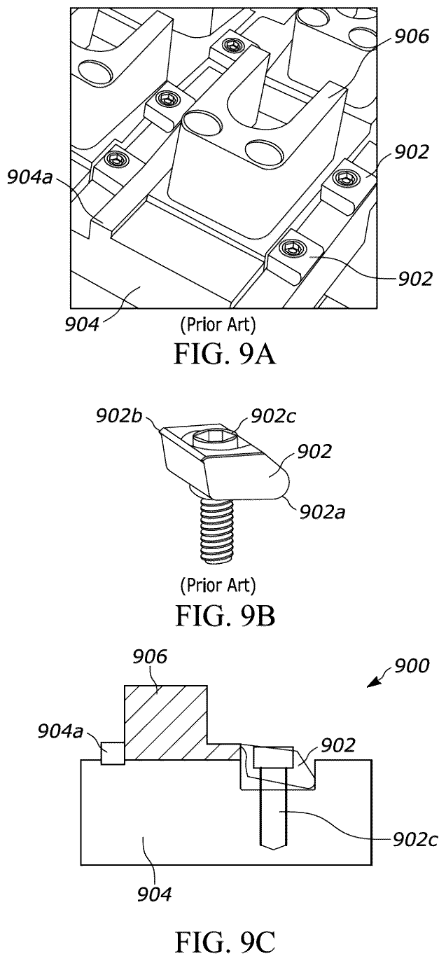

As illustrated in FIGS. 4A and 5-7, the workpiece securing mechanism or apparatus 420 includes an arbor 422, a drive shaft biasing mechanism, such as spring 424, a clutch 426, a drive shaft 428 and tool head, such as tool bit 430. While the bracket used in the drawing figures to illustrate clutch 426 appears to include drive shaft 428, it should be understood that drive shaft 428 is not technically part of clutch 426 but is shown where it is illustrated simply to give orientation of the components and show the axial configuration of same (see FIG. 8 for alternate view). Rather, clutch 426 includes a clutch biasing mechanism housing, such as cup 426a, a biasing member, such as spring 426b, clutch body 426c, clutch balls 426d and their corresponding detent plate 426e. In the form shown, the arbor 422 and cup 426a have mating threading that allow the cup 426a to be rotated with respect to arbor 422 to adjust the amount of compression of spring 426b and, thus, the amount of torque that is required to force the clutch balls 426d out of their mating detents 426e1. For example, in the form shown, the cup 426a has internal threading and arbor 422 has external threading. Thus, the cup can be rotated clockwise to move further onto arbor 422 thereby compressing spring 426b further and increasing the amount of torque that will be required to cause the clutch to engage (meaning to cause the output or drive shaft 428 to disengage from the rotating input shaft or arbor 422. While the threading arrangement shown is preferred, it should be understood that in alternate embodiments, the threading could be reversed such that the cup would have external threading, and the arbor would have internal threading if desired.

Thus, the tool 420 provides a torque limiting fastener driver having a drive shaft 428 that is mechanically linked to a torque limiting device (e.g., clutch 426) that is adjustable to release at a predetermined torque setting. The drive shaft 428 is axially biased via spring 424 which contacts the rear surface of the drive shaft 428 in order to allow axial compliance of the drive shaft 428. The clutch housing or spring cup 426a contains a second spring 426b and is internally threaded to screw onto the tool arbor 422 such that threading the cup further onto the arbor 422 or further off of the arbor 422 allows for torque adjustment. In use, the assembled tool 420 is mounted into a machine center tool holder 410 to form a tool assembly 400 that can be added to the automatic tool changer or tool carousel of the machine center and then used by the machine center to tighten and loosen conventional workpiece securing fixtures to automate this process using only the equipment contained within the machining center itself, rather than requiring manual aid or use of additional equipment to accomplish these tasks.

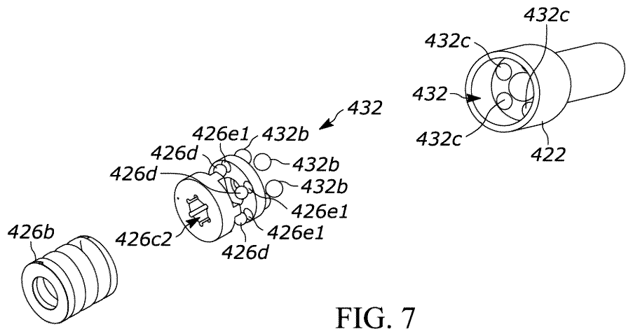

As best illustrated in FIG. 7, the internal opening 426c2 of clutch body 426c is keyed to the shape of drive shaft 428 so that the clutch body 426c rotates along with drive shaft 428 when rotated. In the form shown, the internal opening 426c2 is centered on the clutch body 426c and the central openings of spring 426b and detent plate 426e are not so keyed as clutch body 426c so that they are free to move independently of drive shaft 428. In operation, when the drive shaft is connected to a tool head, such as tool bit 430, and that in turn is connected to the screw (902c) of a conventional clamp system, the rotation of arbor 422 clockwise rotates drive shaft 428 and tool bit 430 to tighten the screw into position (in conventionally threaded clamping systems and not reverse-threaded systems). Once the desired amount of tightness of the screw (902c) is reached (which is determined based on the torque setting of cup 426a), the clutch 426 will disengage the drive shaft 428 from the arbor 422 (e.g., by allowing it to slip and not rotate with the arbor 422 via the clutch balls 426d coming out of their respective detents 426e1 in detent plate 426e (see FIG. 7)). Conversely, to loosen the screw (902c), the arbor 422 would be rotated in the opposite direction (counterclockwise) to unscrew the fastener or screw (902c) to release the workpiece (906). It should be understood that in reverse-threaded systems, the rotation direction would be reversed (e.g., counterclockwise rotation for tightening and clockwise rotation for loosening), but the workpiece securing tool can be configured to accommodate those systems as well, if desired.

In the form shown, the clutch ball seats 426c1 formed in clutch body 426c are configured to only allow the clutch balls 426d to disengage from the arbor 422 when the arbor is rotating in the fastener tightening direction (in this example clockwise rotation). This ensures that even the most stubborn clamp fasteners or screws (902c) will be loosened when desired. In other words, a stubborn screw (902c) will not cause the clutch 426 to disengage the drive shaft 428 from the arbor 422 regardless of the torque experienced on the tool 420. This is achieved via the shape of first clutch ball seats 426c1. When the arbor is rotated in the fastener release direction (in this example counterclockwise rotation), the walls of first clutch ball seats 426c1 have a ramped body that crowd the balls 426d against the arbor 422 when turned counterclockwise so that the clutch cannot disengage the drive shaft 428 from arbor 422. This risk of excess torque may not be of concern in all applications and, thus, in some forms of the invention, a single clutch version of tool 420 may be provided (see FIG. 8 which will be discussed further below). However, in other applications, excessive torque exposure may continue to be a concern for the tool 420 and/or the machine with which the tool is used (e.g., machining center, grinder, mill, router, drill, etc.). In such applications, a version of the tool 420 is provided that has a secondary clutch to prevent damage that could otherwise occur during loosening of clamp screw (902c). In the embodiment shown, a secondary or second clutch is illustrated and referenced by reference numeral 432 as best illustrated in FIGS. 5, 6 and 7. In an effort to conserve space and materials, the secondary clutch 432 is partially integrated into the first or primary clutch 426 by sharing the same detent plate 426e. Thus, one side of detent plate 426e has a first set of detents 426e1 which are used in connection with the first clutch 426; whereas the other (opposite) side of detent plate 426e has a second set of detents 432a which are used in connection with the second clutch 432.

The secondary clutch 432 further includes secondary clutch balls 432a which are seated in clutch ball seats 432b formed on an inner surface of arbor 422. The second or secondary clutch 432 serves as a break away torque clutch or overload clutch to prevent damage occurring to the tool 420, tool holder 410 or machine within which the tool assembly 400 is mounted. Since the intent is to rarely have this secondary clutch activate, the detents 432a and/or seats 432c are cut deeper than the detents 426e1 and/or seats 426c1 so that greater torque is required to activate the secondary clutch 432 than the primary clutch 426 (and preferably but not necessarily, much greater torque). Not only does the secondary clutch 432 protect the tool 420, tool holder 410 and machine to which they are connected, but it also serves as a fallback in case the main clutch 426 fails. Meaning, unlike the primary clutch 426 shown which only operates in one direction of rotation, the secondary clutch 432 operates in either direction so that it addresses the situation where excessive torque is reached when loosening the clamp screw (902c), but it also can serve as a failsafe if the primary clutch fails to work when tightening the clamp screw (902c).

The tool bit end 430 of tool 420 will preferably comprise a socket so that different tool bits can be inserted into the socket for different applications (e.g., a hex head bit or hex bit, a traditional flat or slotted screwdriver bit, a Phillips head screwdriver bit, a Torx head bit, a Torx Plus head bit, a tamper-resistant Torx bit, a tamper-resistant hex bet, a square drive bit, etc.). For convenience, the embodiment illustrated in FIGS. 4A, 4B, 5 and 8 all depict a hex bit inserted in the socket of tool bit 430. More particularly, in the form shown, the tool bit 430 is a socket adapter coupling having a first socket for engaging drive shaft 428 on one end and a second socket for engaging a drive bit (e.g., like the hex bit, slotted bit, Phillips bit, Torx bit, etc. mentioned above). If desired, the bits and/or drive shaft may be provided in ball-end configurations if it is desired to allow for them to be installed and/or used at an angle with respect to the socket. Similarly, it should be understood that the tool 420 could be provided in straight shank, tapered shank configurations for arbor 422 and/or with or without a tool holder (e.g., 410).

As mentioned earlier, the embodiment illustrated in FIGS. 4A-7 all reference a dual clutch tool 420 (or tool 420 having dual clutches, i.e., first clutch 426 and second clutch 432). However, in alternate embodiments, a second or secondary clutch 432 may not be needed or desired. In such instances, rather than having the detent plate 428e and second clutch balls 432b, the apparatus 400 could simply be provided with the one, primary clutch 426 and the primary clutch balls 426d would simply be seated in the ball seats 432c formed on the inner surface of the arbor 422 instead of requiring the detent plate 428e. An example of such an embodiment is illustrated in FIG. 8 and items that are similar to those discussed in FIGS. 4A-7 are referenced using the same latter two-digit reference numeral but having the prefix “8” instead of “4” (merely to distinguish one embodiment from the other). Thus, in this embodiment, the tool assembly 800 includes a tool holder 810 and tool 820. For convenience portions of the figure (e.g., 826a and 822) are shown translucent to make it more clear how the parts assemble to one another (e.g., how they thread together). As with the earlier embodiment of FIGS. 4A-7, the tool holder 810 includes a tool holder body 812, a tool holder collet 814 and tool holder clamp 816. Similarly, the tool 820 includes an arbor 822, a biasing mechanism, such as spring 824, a clutch 826, a drive shaft 828 and a tool bit end 830. Unlike the prior clutch embodiment (426), however, the tool 820 has only a single clutch 826. The clutch 826 has a clutch housing or receptacle, such as cup 826a, a clutch biasing mechanism such as spring 826b, clutch body 826c and clutch balls 826d. The clutch balls 826d are seated in depressions or seats formed in an inner surface of arbor 822 (much like what is shown in FIG. 7 (432c)), and the opposite side of the clutch balls 826d would rest in detents formed on clutch body 826c (much like what is shown in FIG. 6 (432a)) making the clutch body 826c serve the dual role of clutch body and detent plate. The cup 826a and arbor 822 would have mating thread structures so that the torque level that activates the clutch 826 could be adjusted (e.g., rotating the cup in a first direction to compress spring 826b further thereby requiring more torque to activate the clutch 826, or rotating the cup in a second direction (opposite the first direction) to put less compression on spring 826b so that less torque is required to activate the clutch 826.

Regardless of the configuration selected (i.e., that of FIGS. 4A-7 or that of FIG. 8), the workpiece securing tool (420, 820) and tool holder (410, 810) (i.e., the tool and tool holder assembly 400, 800) are designed to be loaded as a selectable tool from a plurality of tools in the tool carousel of the machine center. The machine center is programmed to select this tool to tighten and loosen the clamp screws, thereby making the process a fully automated one that does not require the use of additional equipment, but rather simply the equipment contained on the machine itself. This eliminates the need for an operator to perform the time-consuming and monotonous task of manually tightening and loosening each workpiece securing mechanism (e.g., clamps). By automating same, it should speed up the workpiece securing process exponentially, make the process much more consistent and repeatable, and reduce (if not eliminate) the risk for human error which can cause damage to workpieces, tools, tool holders, and the ultimate machines that utilize same. In fact, it should greatly improve the efficiency of the manufacturing process in each shop and improve the throughput rates of all projects coming through these workshops.

Further, the tool (420, 820) is designed such that the machining center can grab the tool 420, 820 (e.g., via the tool holder 410, 810 if present or simply via the arbor 422, 822 if no tool holder is used) and, with the tool (410, 810) in the machine spindle, the machine is programmed to move the tool (420, 820) toward the clamp fastener. The tool (420, 820) then contacts the head of the fastener and travels past just touching such that the drive shaft (428, 828) of the tool (420, 820) is moved axially (e.g., toward the arbor 422, 822) compressing the drive shaft biasing spring (424, 824). This puts a preload on the tool bit (430, 830) in contact with the clamp fastener keeping it engaged during the tightening and loosening process. The axial spring bias of spring 424, 824 also allows for compliance along the longitudinal axis (e.g., vertical compliance in a vertical machining application) during tightening and loosening where the conventional clamp screw moves axially down (e.g., screwed in) and up (e.g., screwed out), respectively, when turned.

Returning now to the initial drawing figures, in FIG. 1 a horizontal machining center is shown and referenced by reference numeral 100. The machining center 100 includes a bed 102 for supporting a workpiece, a high speed spindle 104 and an automatic tool changer 106 comprising a tool carousel that allows the machining center 100 to select from a variety of tools to perform work on the workpiece. With the new workpiece securing tool disclosed herein, a new tool (e.g., tool assembly 400, tool assembly 800, etc.) is added to the carousel of tools 106 that the machining center 100 can choose from, but this new tool (e.g., tool assembly 400, tool assembly 800, etc.) performs the added function of securing and releasing the workpiece via conventional workpiece securing clamp systems like those discussed previously. Thus, the tools of the tool carousel 106 and machining center 100 do not just perform work on the workpiece, but also now may secure and release the workpiece to the bed 102 of the machining center 100 or any fixture that has been mounted to the bed 102 of the machining center 100. The tool assemblies disclosed herein (400, 800) could be used with any machining center, whether it be an introductory level unit or the most high-end model on the market (e.g., including those having pallet loaders or pallet loading stations and pallet indexing stations, etc.).

FIG. 2 illustrates an alternate machining center 200 which is a vertical machining center. Like the machining center 100 of FIG. 1, the vertical machining center 200 includes a bed 202, a high-speed spindle 204 and an automatic tool changer 206 (or tool carousel). Here, like the embodiment of FIG. 1, the tool assembly (400, 800) can simply added as one of the available tools for the machining center 200 to select from, however, instead of using tool 400, 800 to perform work on the workpiece, it would instead be used to perform work on the workpiece securing mechanism or apparatus (e.g., fastening or releasing, etc.) such as the conventional clamping systems discussed herein which could either be directly mounted to the bed 202 or to a fixture mounted to the bed. The machining center 200 would be programmed via the controller 208 to select the tool assembly (400, 800) and to operate the conventional clamping fixture secured (either directly or indirectly) to bed 202.

The concepts discussed herein particularly with respect to tool 420, 820 could be used with numerous other types of machinery (some with tool holder 410, 810, and some without same). An example of an alternate machine that the tool 420, 820 could be used with is illustrated in FIG. 3 which shows a conventional milling machine 300. Like the other machines, the milling machine 300 includes a bed for supporting a workpiece and/or workpiece clamping fixture, has a high-speed spindle 304 and an automatic tool changer/tool carousel 306 within which the tool 420, 820 may be stored. In most applications a controller would also be mounted to the milling machine 300 (such as a CNC controller, etc.) to automate at least some of the processes run by the milling machine 300. Like the other machines discussed above (e.g., 100, 200), the milling machine 300 could be programmed to select the tool 420, 820 to operate a conventional workpiece securing mechanism (e.g., a conventional workpiece clamping system or fixture), to help expedite the installation and removal of workpieces and the machining process in general related to performing work on same. This would also eliminate (or greatly reduce) the human error element mentioned herein and lead to a much more efficient and repeatable machine shop process that can be performed with great repeatability and accuracy.

Thus, in view of the above, it should be understood that not only is a workpiece securing tool disclosed and contemplated herein, but many other concepts are also disclosed and contemplated herein including without limitation: a workpiece securing tool with first and second clutches each operable separate from the other; an integrated clutch structure that operates as a primary clutch in a first circumstance and as a secondary clutch in a second circumstance different than the first; an integrated clutch structure that operates as a primary clutch in a first instance and as a secondary, backup clutch to the primary clutch in a second instance; a secondary break away torque clutch; an axial compliant torque limiting fastener driver; a torque limiting fastener driver with adjustable torque settings; a workpiece securing tool and tool holder assembly that are selectable from a plurality of tools in a tool carousel for a machine; a torque limiting device; a torque limiting device that limits torque in a plurality of manners (or at least two ways) to prevent damage to the clamp screw, the tool, the tool holder (if present) and/or the machine utilizing the tool; and methods related to all of the above.

Further, it should be understood that software, processors and apparatus/systems are also contemplated herein, including for example, machine program modules for utilizing the tools and tool holders discussed above. In one form, the machine may include a computer aided design (CAD) system and/or a 3D data capture system (e.g., for sampling the surface of a physical object). Such systems can be used to make a geometric model of the workpiece to be machined, but they can also be used to make a model of the workpiece securing fixture (e.g., the clamp fixture), as well. The 3D model can be manipulated, analyzed, and/or modified via the system. When the fixture is ready to be actuated to secure the workpiece in position within or in relation to a machine, the system according to the 3D model and auxiliary data such as materials, processes, dimensions, errors, etc. are converted into electronic instructions for selecting and controlling the tool and tool holder to actuate the workpiece securing fixture fasteners (e.g., clamps). The conversion process is typically supported by a computer-aided manufacturing (CAM) system. The resulting electronic instructions (“machining code”) are usually numerical control (NC) of G code, M code, etc. (generally called “G code”) as defined by the ISO 6983/RS274D standard. It is in the form of a programming language that a processor is programmed with or can read and execute. In one form, M-code and/or G-code are used, such as M-29, to turn on rigid tapping and G84 (Z, R, F) to set the parameters of the tapping (Z=depth of hole, R=retract value, F=pitch of thread). This teaches the machine to select the proper tool and tool holder, and to position it in alignment with the workpiece holding fixture (e.g., the clamps or fasteners of same) to either secure the workpiece via the workpiece holding fixture or release same. These modules could be a canned subroutine supplied by a provider of same (e.g., Fanuc), or the machine manufacturer (e.g., Mazak, Makino, OK, Haas, Hurco, etc.). They could also be a program module added to CAM software such as GibbsCAM, Mastercam, SolidWorks CAM, CAMWorks, BobCAD-CAM and NX CAM (or the like), just to name a few. Thus, an end user can either program a CNC machine center by inputting machine code one line at a time using the machine center control console or the programming can be simplified by using a CAM (Computer-aided manufacture) software package. This software allows the end user to select machining operations and the software automatically writes a machine coded program. The machine coded program is then loaded into the machine center control where it is ready to run when the user wants to secure or release a workpiece that the machine is to (or has) performed work on. There are many CAM software packages available, but they all perform the same basic function of writing machine-ready programs without the need to enter individual lines of CNC machine code. In a preferred form, a new programming subroutine could be added to the CAM software to handle the tightening and loosening of the clamp fasteners. U.S. Pat. No. 10,817,526B2 issued Oct. 27, 2020 to Jones et al. (assignee Machine Research Corporation) explains such coding further and is incorporated herein by reference in its entirety.

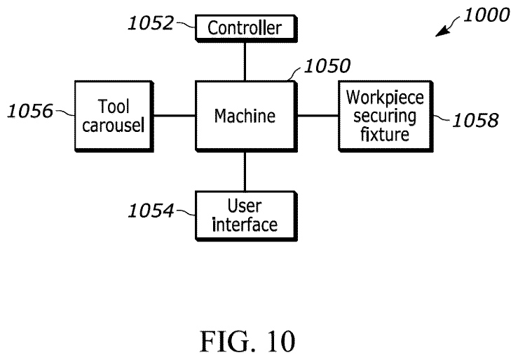

Thus, in addition to the tool, tool holder, and machine using same, it should be understood that disclosed herein is an apparatus and system for programing and using such tool and/or tool holder. For example, in the form illustrated in FIG. 10, an apparatus or system for actuating a workpiece securing fixture is illustrated and referenced generally by reference numeral 1000. The apparatus 1000 includes a machine 1050 having a controller 1052 user interface 1054 for interacting with the machine 1050. The apparatus 1000 further includes a tool carousel 1056 for storing tools for use with the machine 1050. The tool carousel 1056 containing a tool for actuating a workpiece securing fixture as described above to either tight or loosen a workpiece on the workpiece securing fixture. While the illustration of FIG. 10 shows the controller 1052, user interface 1054, tool carousel 1056 and workpiece securing fixture 1058 all spaced from the machine 1050, it should be understood that any or all of these items may be integrated into the machine 1050, if desired. In a preferred form, the machine 1050 and controller 1052 and user interface 1054 form a processor based system configured to read instructions input from the user interface and select the tool when desired to actuate the workpiece securing fixture 1058.

The controller 1052 of apparatus or system 1000 includes a processor and memory so that the apparatus or system 1000 provides a method comprising storing coordinates of fasteners on a workpiece securing fixture into memory (located with controller 1052), and utilizing the stored coordinates from memory to tighten or loosen the fasteners on the workpiece securing fixture 1058. In a preferred form, running a program via the processor based system (located with controller 1052) for determining the coordinates of the fasteners on the workpiece securing fixture 1058. However, it should be understood that as explained above, in alternate forms, a CAM software package may simply be provided so that the user does not need to stand at the user interface 1054 programing in the locations of the fasteners (e.g., clamps) of the workpiece securing fixture 1058. Alternatively, however, that can in fact be done right at the machine 1050 itself via the user interface 1054, if desired.

Thus, disclosed and contemplated herein is a non-transitory storage medium storing a computer program executable by a processor based system, the computer program causing the processor based system to execute steps comprising: obtaining coordinates of fasteners on a workpiece securing fixture; loading a tool for actuating the fasteners on the workpiece securing fixture; and actuating the fasteners on the workpiece securing fixture via the tool to secure or release a workpiece to the workpiece securing fixture utilizing the stored coordinates of the fasteners. As mentioned above, in some forms, obtaining coordinates of fasteners comprises either obtaining the coordinates from a stored memory location or, alternatively, running a program to locate the coordinates of the fasteners on the workpiece securing fixture. The running of the program may only need to be done once so that the coordinates are then stored in memory from that period on. Alternatively, it may be desirable to run that program each time to accommodate changes in the location of the workpiece securing fixture or the use of different fixtures.

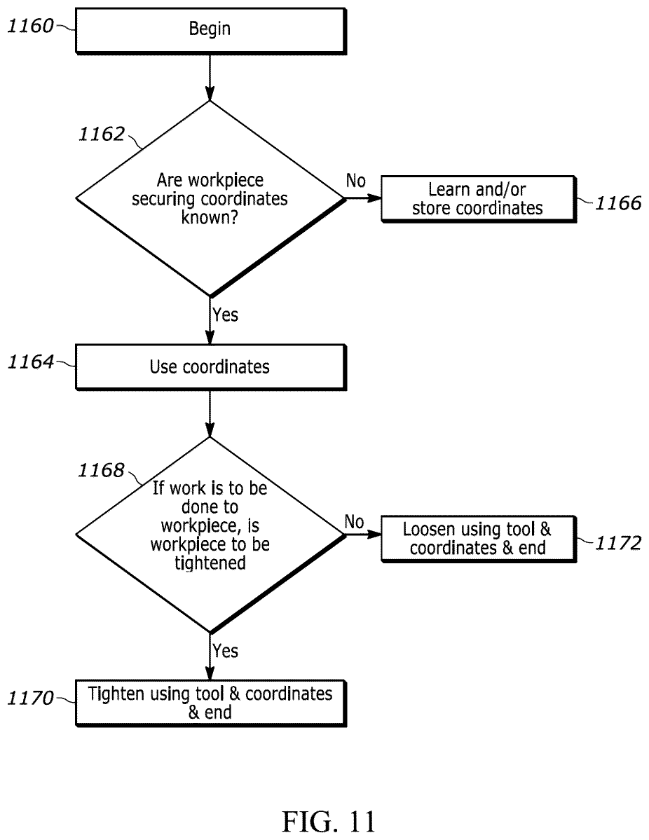

A simple software program or logic routine is illustrated in FIG. 11 illustrating how the machine may operate in accordance with this disclosure. For example, in the form shown, the routine starts in step 1160 and moves to a decision step 1162 inquiring if the coordinates of the workpiece securing fixture fastener (e.g., clamps) are known. If so, the routine moves to step 1164 and uses the coordinates and the tool disclosed herein to secure the workpiece securing fixture fasteners to secure the workpiece to the workpiece securing fixture. Alternatively, if the coordinates are not known in step 1162, the routine moves on to step 1166 to obtain the coordinates and/or store them to memory if desired. Obtaining the coordinates may simply entail looking at a local memory location containing same or even local area network (LAN), or it may entail accessing a remote database with this information, such as a cloud-based database or remote database accessed over a wide area network (WAN) such as via the Internet. Once obtained, the system may store those coordinates to memory so that this process does not have to be done again, or the system can be configured to do this step every time, if desired. Once the coordinates are obtained, the routine returns from step 1166 to step 1164 where those coordinates are used. The routine then asks if a work instruction has been received and, if so, whether workpiece is to be tightened in step 1168. If so, the program uses the tool disclosed herein and the coordinates in step 1170 to tighten the workpiece to the workpiece securing fixture via the workpiece securing fixture fasteners (e.g., clamps). If the workpiece is not to be tightened (i.e., it is to be loosened) in response to decision step 1168, the routine uses the tool disclosed herein and the coordinates to loosen the workpiece with respect to the workpiece securing fixture in step 1172 and ends the routine. While decision step 1168 asks if the workpiece is to be tightened, it should be understood that in alternate versions that step could ask the opposite (e.g., is the workpiece to be loosened), etc. It is simply intended to be a representative decision step as to whether or not the workpiece securing fixture fasteners need to be tightened or loosened so that the corresponding desired action is taken.

It should also be appreciated that associate methods for manufacturing, assembling and customizing workpiece securing mechanisms like those discussed above are also contemplated herein, along with other methods. For example, a method of securing workpieces via conventional clamp systems and a tool stored in the automated tool changer of a machine are disclosed herein. A method of assembling a workpiece securing tool is also disclosed herein. As is a method of securing a workpiece using a workpiece securing tool as described herein. Further, various methods of clutching or torque limiting a workpiece securing tool are disclosed herein. For example a method of operating a workpiece securing tool is disclosed having a clutch (or torque limiting feature) for preventing damage to at least one of the conventional workpiece clamping system, the tool, the tool holder, the tool assembly or the machine using the tool. In another form, a method of operating a workpiece securing tool is disclosed having a first clutch (or torque limiting feature) for preventing damage from occurring when securing the workpiece and a second clutch (or torque limiting feature) for preventing damage from occurring when releasing the workpiece. Another method disclosed herein is a method of integrating two separate clutches (or torque limiting features). A method of operating a workpiece securing tool with first and second clutches each operable separate from the other is also disclosed. As is a method of integrating clutch structures to operate as a primary clutch in a first circumstance and as a secondary clutch in a second circumstance different than the first. Similarly, a method of integrating clutch structures is disclosed to operate as a primary clutch in a first instance and as a secondary, backup clutch to the primary clutch in a second instance. A method of providing a secondary break away torque clutch (or torque limiting feature) is provided. A method of torque limiting an axial compliant torque limiting fastener driver is also provided, as is a method of adjusting torque settings for a torque limiting fastener driver. A method of selecting a workpiece securing tool and tool holder assembly from a plurality of tools in a tool carousel for a machine is also disclosed. A method of producing a torque limiting device for a machine is disclosed. A method of torque limiting in a plurality of manners (or at least two ways) to prevent damage to at least one of the clamp screw, the tool, the tool holder (if present) and/or the machine utilizing the tool is disclosed. Additional methods disclosed and contemplated herein are methods of protecting a workpiece securing tool and methods of protecting a machine using a workpiece securing tool.

While the embodiments illustrated above with respect to FIGS. 4A-8 work well in many applications, heavy industrial and machining applications may present too much internal friction on the tool and cause seizing of the bearings and/or spring actuation/functioning, and thus, when torqued too hard, the tool may bind-up (e.g., either causing the axial compliance provided by the integrated clutch of clutch 426 and/or clutch 432 to fail, and/or the longitudinal compliance provided by spring 424 to fail) and thereby cause issues for the tool, tool holder incorporating same, and/or the machine using same. In order to overcome these issues, alternative embodiments may be used that make the tool more robust to account for the stresses incurred by such heavy industrial or machining applications and the high torque conditions experienced in same.

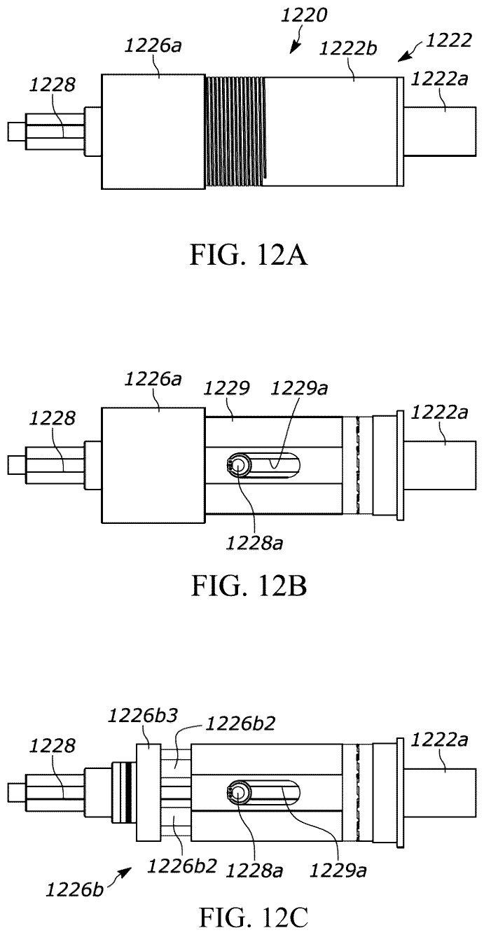

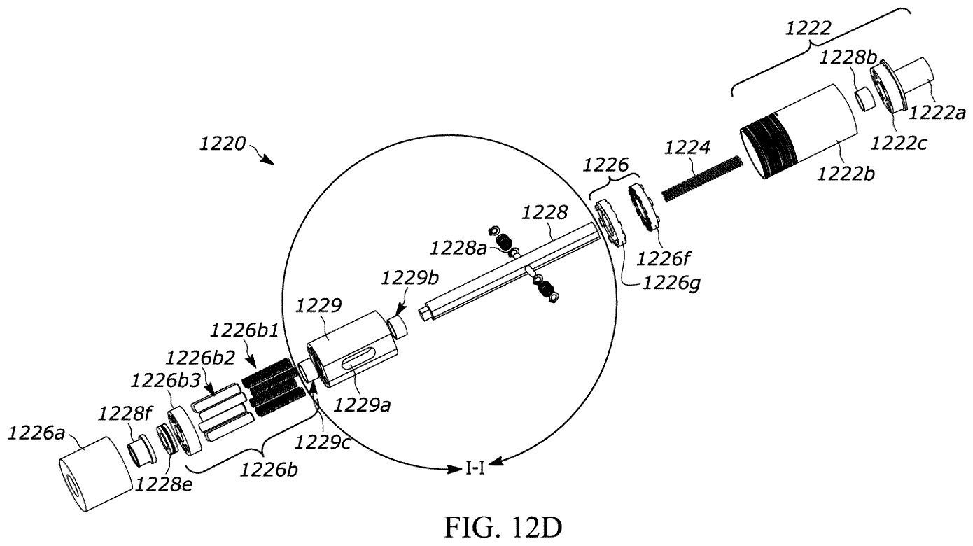

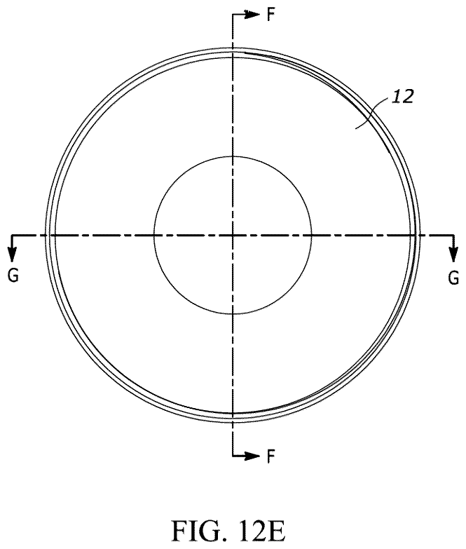

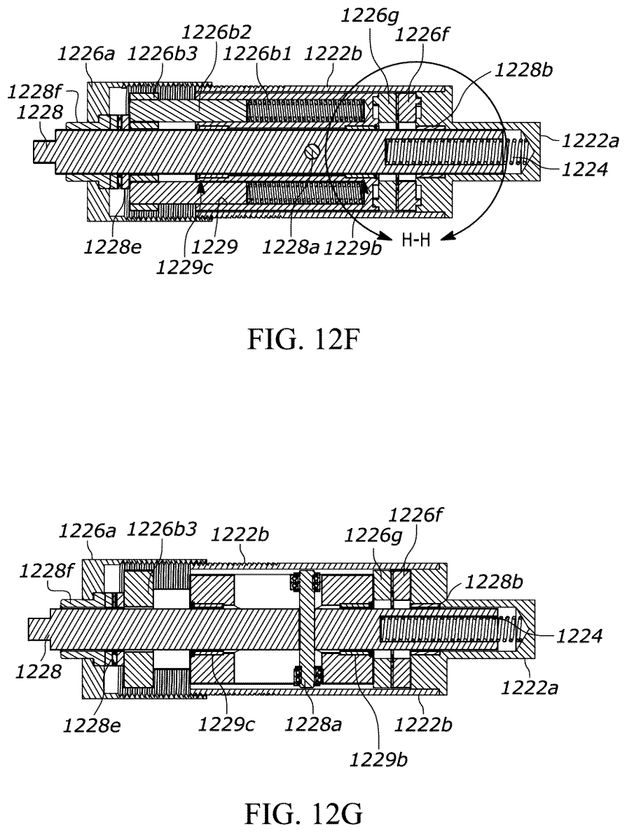

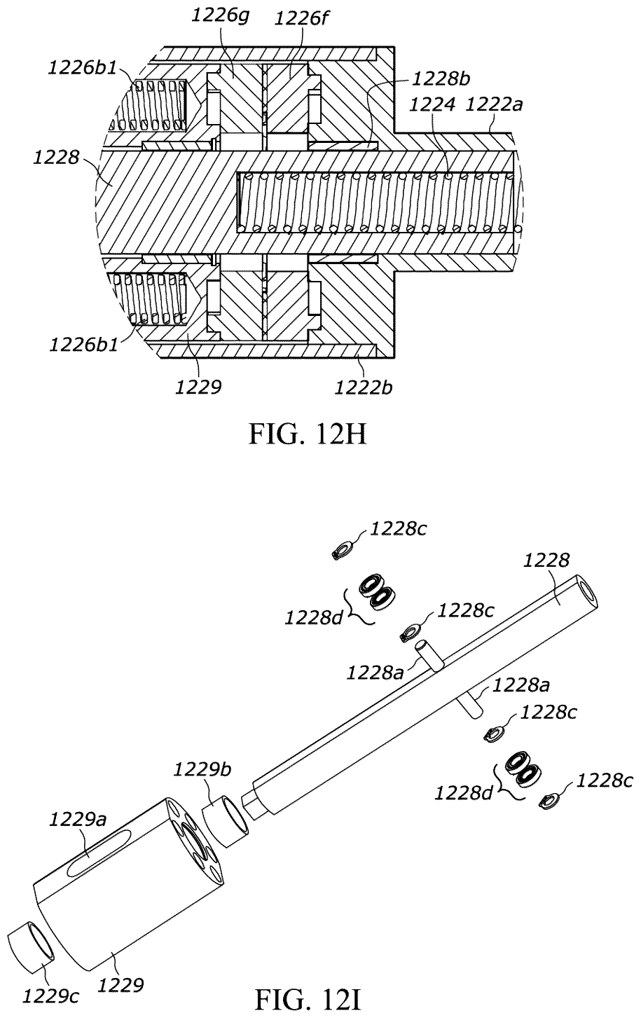

For example, one form of an alternate embodiment is illustrated in FIGS. 12A-I which eliminates ball bearings in favor of using male and female mating structures (e.g., an arm or pin and mating guide channel configuration) to allow for longitudinal compliance, while using simple clutch surfaces and spring compression for axial compliance (and adjustments thereof). In this embodiment items that are similar to those already discussed use the same latter two-digit reference numeral but include the prefix 12 (e.g., the tool is referred to generally by reference numeral 1220, in similar manner to how the above described tool embodiments were referred to generally by reference numerals 420 and 820, respectively). With this configuration, the longitudinal compliance structure actually helps assist the tool in dealing with the stresses of torque and therefore gives the tool more torque capacity as will be discussed further below.

In FIG. 12A, a side elevational view of the alternate workpiece securing tool 1220 is shown having an alternate compliance arrangement in accordance with other aspects of the invention. FIG. 12B is a similar side elevational view to that of FIG. 12A but with the outer arbor extension or sleeve 1222b removed or made invisible so that internal workings of the tool 1220 can be seen. More particularly, with the outer arbor extension or sleeve 1222b removed, an alternate longitudinal compliance structure is shown consisting of a drive shaft housing 1229 that includes a guide, such as guide channel or opening 1229a, for orientating and guiding a protrusion extending from drive shaft 1228, such as drive shaft arm or pin 1228a and a biasing mechanism such as spring 1224. The ability for the drive shaft 1228 and drive shaft arm or pin 1228a to move along the longitudinal axis of the drive shaft 1228 gives the tool 1220 longitudinal compliance to ensure the driving implement connected to the distal end of the drive shaft 1228 (not shown) does not damage the fastener it is driven into engagement with (not shown, but similar to 902c), but also ensures the driving implement stays engaged with the fastener (902c) as it is tightened into the work fixture (904) to secure a workpiece (906) thereon. FIG. 12C is a similar side elevational view to that of FIGS. 12A-B but with both the outer arbor extension or sleeve 1222b and the clutch cup 1226a removed or made invisible so that more internal workings of the tool 1220 can be seen. For example, with the clutch cup 1226a removed, an alternate configuration of the axial compliance biasing mechanism 1226b is shown. In particular, spring push pins or members 1226b2 are shown, as is the spring push pin or member holder 1226b3. This biasing mechanism 1226b can be adjusted by rotating the clutch cup 1226a to either tighten it onto the threaded end of arbor extension or sleeve 1222b to compress the biasing mechanism 1226b and require more torque to cause the axial compliance structure (clutch 1226) to disengage, or loosen the clutch cup 1226a by rotating it in the opposite direction to loosen it along the threaded end of arbor extension or sleeve 1222b to expand the biasing mechanism 1226b and require less torque to cause the axial compliance structure (clutch 1226) to disengage. These features are more clearly illustrated in FIGS. 12D-12I and will be explained in more detail now.

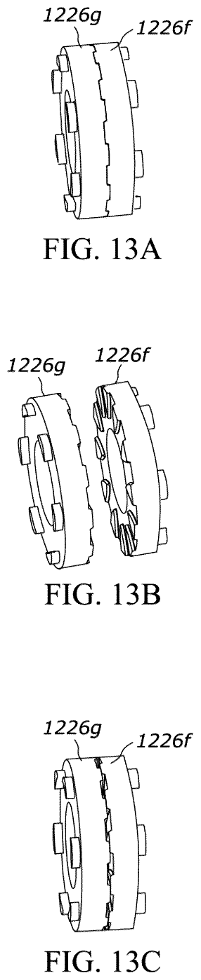

FIG. 12D is an exploded view of the workpiece securing tool of FIGS. 12A-12C. For convenience, we will now explain all of the structures shown in this figure starting with arbor 1222. Like with prior embodiments, tool 1220 includes an arbor 1222, but unlike prior embodiments, this arbor 1222 includes a main arbor body 1222a and an arbor extension or sleeve 1222b. The main arbor body 1222a includes a mating structure 1222c for mating with one portion of axial compliance structure 1226. In the form illustrated, the mating structure is a plurality of recesses or detents that receive mating protrusions from the axial compliance structure 1226 to hold that portion of the axial compliance structure 1226 in place so that it always rotates along with the arbor 1222 (specifically main arbor body 1222a). The main arbor body 1222 also defines a central recess that receives drive shaft rear bushing 1228b and a longitudinal compliance biasing mechanism such as spring 1224. The spring 1224 is disposed within an opening defined by the end of drive shaft 1228 and the drive shaft extends through the drive shaft rear bushing 1228b as best illustrated in FIGS. 12 and 13.

Moving down tool 1220, the arbor extension or sleeve 1228b is connected to main arbor body 1228a on a first end such that it rotates therewith (e.g., it may be keyed to the main arbor body 1228a, fastened to it, welded, etc.). The arbor extension or sleeve 1228b has external threading on a second end opposite the first end to engage with internal threading of clutch cup 1226a. The effect of this threaded engagement will be discussed further below and has already been discussed above. Next is the axial compliance structure 1226. Like the embodiment of FIG. 8 (clutch 826), the instant embodiment has a single integrated clutch 1226 (rather than two separate clutches as in FIG. 4 with primary clutch 426 and secondary clutch 432)). In this embodiment, however, the clutch 1226 is made up of first clutch plate 1226f and second clutch plate 1226g. The clutch plates 1226f, 1226g define a central opening through which drive shaft 1228 extends (see FIGS. 12F & 12G). The first clutch plate 1226f has a mating structural relationship with arbor main body 1222a. In this form, first clutch plate 1226f has a plurality of protrusions on one side which mate with the plurality of recesses 1222c defined by arbor body 1222a so that the first clutch plate 1226f will always rotate with arbor 1222. On the other side of first clutch plate 1226f (the side opposite the first side), the first clutch plate has teeth or pins that engage with and drive mating teeth or pins located on one side of the second clutch plate 1226g. The other side of second clutch plate 1226g (the side opposite the side with teeth) has further protrusions for matingly connecting the second clutch plate 1226g with drive shaft housing 1239 so that second clutch plage 1226g will always rotate with drive shaft housing 1239.

As is best illustrated in FIGS. 12H and 13A-C, the mating teeth of the first and second clutch plates 1226f, 1226g are angled or sloped to allow the teeth to slip with respect to one another once a predetermined amount of torque has been reached in order to prevent tool 1220 from damaging itself, the workpiece or fastener it is used in connection with or the machine it is used in connection with. In the form shown, the sloping of the teeth in the clockwise direction allows for the teeth to slip at a lower torque level (or threshold) than in the counterclockwise direction. The reason for this is it may take additional breaking force to free (or release) a fastener that has already been tightened such as to a fixture (e.g., 902c to 904). In the embodiment shown, the ratio between the different sloped edges of the teeth to accommodate this varied or different slippage is 1.125 to one. In this specific example, the clockwise engaging tooth angle is twenty two and one half degrees (22.5°) and the counterclockwise engaging tooth angle is twenty five degrees (25°). In an alternate embodiment, the teeth or pins have two ground edges, with one being at thirty degrees (30°) and the other edge being ground to twenty two and a half degrees (22.5°). It should be understood that these are merely examples of what teeth angles and ratios can be used and numerous other angles and ratios are intended to be covered herein (e.g., they are preferred for this particular application, but there are numerous other applications that they could be adjusted to accommodate).

FIG. 13A shows the axial compliance structure or clutch with clutch portions 1226f and 1226g in their engaged position such that rotation of the drive shaft 1228 in the clockwise orientation causes the tool 1220 to fasten a fastener (e.g., fasten fastener 902c into the fixture 904) until the predetermined torque threshold has been reached. Once that threshold has been reached, the clutch portions 1226f and 1226g will disengage as shown in FIG. 13C (meaning the teeth have slid up their respective ramp surfaces until the separate portions are disengaged thereby allowing the arbor to continue to spin without requiring the drive shaft to continue spinning so as not to damage the arbor, the machine driving the arbor, the tool previously coupled to the arbor, any fastener coupled to the drive shaft, or the workpiece being worked on). Conversely, when the drive shaft 1228 is rotated in the counterclockwise orientation, the tool 1220 will loosen a fastener until the predetermined torque threshold has been reached. Once that predetermined torque threshold has been reached, the clutch portions 1226f and 1226g will cause the teeth of each clutch portion 1226f, 1226g to slide over one another until the clutch portions 1226f, 1226g disengage from one another as shown in FIG. 13C to again allow the drive shaft to decouple from the arbor so as not to damage the arbor, the machine driving the arbor, the tool previously coupled to the arbor, any fastener coupled to the drive shaft, or the workpiece being worked on. As mentioned above, in a preferred form, the clutch portions 1226f and 1226g will allow for higher torque to be applied in the counterclockwise orientation to allow for a breaking force that may be required to start to loosen the fastener. The amount of torque required to cause the clutch portions 1226f, 1226g to disengage can be adjusted by rotating clutch cup 1226a (e.g., screwing clutch cup 1226a further onto arbor extension 1222b will result in the clutch portions 1226f, 1226g requiring more torque to be reached (e.g., a higher torque threshold to be met) before disengaging; while conversely unscrewing the clutch cup 1226a further off the arbor extension 1222b will result in the clutch portions 1226f, 1226g requiring less torque to be reached (e.g., a lower torque threshold to be met) before disengaging). In a preferred form, the outer surface of the clutch cup 1226a, the arbor extension 1222b or both will be marked with indicia (e.g., a scale, alternate torque setting markings, etc.) to indicate to the user what the torque threshold will be as the clutch cup 1226a is rotated with respect to the arbor sleeve 1222b.

Again, it should be understood that the directions of rotation of the components discussed herein are exemplary and could be reversed if desired. For example, if it is desired for the drive shaft to rotate in the counterclockwise orientation to loosen a fastener that can be done. Similarly, alternate springs 1226b1 or push pins 1226b2 may be used either in combination with the above or as an alternate way in which torque threshold can be adjusted. These features will be discussed further below. The terms disengage are used in a manner to mean the clutch portions 1226f, 1226g are allowed to slip with respect to one another (or move without driving one another or one driving the other), but this does not necessarily mean full disengagement where one portion 1226f, 1226g is fully removed from the other portion 1226g, 1226f. Similarly, the use of coupled or engaged does not require direct coupling or engagement, but rather could entail indirect coupling or engagement if desired (or unless specified to the contrary).

Further down the drive shaft 1228 is part of the alternate embodiment of the longitudinal compliance structure including drive shaft arm or pin 1228a and drive shaft housing opening 1229a in drive shaft housing 1229. In the form illustrated, the drive shaft arm or pin 1228a is disposed through the drive shaft 1228 and extends from opposite sides of drive shaft 1228 into the openings 1229a which are located on opposite sides of drive shaft housing 1229 (e.g., in a male female mating relationship). To assist with longitudinal movement of the drive shaft 1228 with respect to drive shaft housing 1229, the drive shaft arm or pin 1228a includes on each side of the drive shaft 1228, a pair of fasteners, such as snap rings 1228c, and a pair of bearings 1228d captured between the pair of snap rings 1228c. The bearings 1228d are secured in position on the drive shaft arm or pin 1228a via the snap rings 1228c and are nested in the openings 1229a defined by drive shaft housing 1229 such that they allow the drive shaft arm or pin 1228a to smoothly travel (e.g., allow the bearings 1228d to roll) along the longitudinal axis of the drive shaft 1228 within the openings 1229a. This configuration not only allows for smooth longitudinal compliance motion, but also serves as a means to resist (or reduce the impact of) torque and the impact torque could have on the compliance structures and tool 2020 itself. For example, the bearings 1228d are positioned as far out on the drive shaft arm or pin 1228a to give the tool 1220 more torque capacity (e.g., by doing so it achieves the longest moment arm that can be used in this particular design to improve torque capacity of the tool).

Next, the drive shaft 1228 is disposed within drive shaft housing 1229 which has the drive shaft housing openings 1229a. In a preferred form, the drive shaft housing further includes bushings 1229b and 1229c positioned on opposite ends of drive shaft housing 1229 to further stabilize, guide, and align the drive shaft 1228 therein and to better help the drive shaft housing 1229 rotate along with the drive shaft 1228. In addition, the drive shaft housing 1229 defines a plurality of openings within which the plurality of springs 1226b1 are at least partially disposed (as can best be seen in FIGS. 12D and 12F). In a preferred form and as shown in FIG. 12F, the plurality of springs 1226b1 are fully inserted into the openings or cavities defined by drive shaft housing 1229, such that the plurality of push pins 1226b2 are also partially disposed within the openings or cavities defined by drive shaft housing 1229. The opposite ends of each push pin 1226b2 are disposed in a housing, such as push pin holder 1226b3. Note that the openings or cavities formed by drive shaft housing 1229 do not pass all the way through the drive shaft housing 1229. Rather, the springs 1226b1 are nested in the openings or cavities of drive shaft housing 1229. Although the image of drive shaft housing 1229 appear to show openings on the opposite end of drive shaft housing 1229, it should be understood that those are mating structures for mating with the lower portion of the axial compliance structure (1226) (e.g., clutch portion 1226g). In a preferred form, the mating structure will key clutch portion 1226g to drive shaft housing 1229 so that the two items rotate with one another.

In the form shown, rotation of clutch cup 1226a in the clockwise direction, causes the drive shaft 1228 to push on the longitudinal compliance structure (spring 1224) and further compress same which reduces the amount of longitudinal compliance that can be achieved by tool 1220; but also causes the push pins 1226b2 to push on the plurality of springs 1226b1 to further compress those, which in turn, causes the drive shaft housing 1229 to press harder on the axial compliance structure (1226) so that the torque threshold required to cause clutch portions 1226f, 1226g increases. Conversely, rotating the clutch cup 1226a in the counterclockwise direction on arbor sleeve 1222b causes the drive shaft to move away from main arbor body 1222a, allowing longitudinal compliance structure (spring 1224) to expand; and causes holder 1226b3 and pins 1226b2 to move away from main arbor body 1222a, allowing springs 1226b1 to expand and reduces the amount of force with which the drive shaft housing 1229 presses against the axial compliance structure (1226) and thereby lowers the amount of threshold required in order to have the clutch portions 1226f, 1226g to disengage from one another.

Further down the drive shaft 1228 is a thrust bearing 1228e and the drive shaft front bushing 1228f which help align the drive shaft 1228, allow it to rotate along with arbor 1222, but also allow it (the drive shaft 1228) to disengage from the arbor 1222 when the predetermined torque threshold has been reached to prevent damage from being done to the arbor, the machine to which it is connected, the tool to which it is connected, the fastener to which it is connected via drive shaft 1228, and/or the fixture to which the fastener is connect (and possibly even the workpiece positioned on the fixture). A thrust bearing is used for bearing 1228e to support the axial load of the application and this allows the shaft 1228, drive shaft housing 1229, and clutch portion 1226f to stop moving once the torque threshold has been reached for axial compliance structure (1226), while still allowing the front bushing 1228f, clutch cup 1226a and arbor 1222 to continue to rotate until the machine operating arbor 1222 is stopped. FIG. 12F is a cross-sectional view of the workpiece securing tool of FIGS. 12A-E taken along line F-F as illustrated in FIG. 12E and shows the clutch portions 1226f, 1226g of axial compliance structure (1226) when they have disengaged from one another (similar to what is shown in FIG. 13C). While the arbor main body 1222a continues to drive clutch portion 1226f, the configuration allows clutch portion 1226g to rotate with respect to clutch portion 1226f when the torque threshold has been reached.

While the above exemplary embodiments have been focused on use of the inventive concepts discussed herein in a more industrial setting such as a machining setting, it should be understood that these concepts can be used in numerous applications and settings. For example, the concepts could be implemented in a tool accessory or feature for use in a less industrial application, like with a benchtop drill press (instead of a machine center) which may be used by a hobbyist (rather than a trained machinist), or even with a simple handheld cordless drill. Alternatively, it may be an accessory for use with other types of rotational tools such as a handheld drill. In both these applications, the accessory may use one or all of the concepts discussed herein (e.g., it may use just a primary clutch feature to offer axial compliance in one direction, alternatively it may use just the secondary clutch feature offering axial compliance in a second (different) direction, still further, it may use just the longitudinal compliance, and is still other forms it may use one or more (or even all) of any of these features. Similarly, these features could be built-in to such alternate, less industrial, tools (not merely an accessory) just like they could with the larger more industrial machines discussed herein. Thus, tool accessory or accessory as used herein does not mean the concepts disclosed herein are only provided as an accessory attachable to another component, but rather are intended to connotate a feature which may be an attachable accessory in some applications or alternatively may be a feature of a tool or integrated into a tool itself and not attachable as a standalone accessory.

While keeping the above in mind, it should be understood then that numerous different embodiments are disclosed that capitalize on features of the invention. For example, in some instances, the embodiment embraces a tool (e.g., whether integrated into the tool or as an accessory (itself being a tool) attachable to another tool), in other instances it may include the tool and a tool holder of the type used by machining centers which are routinely placed in the spindle of the machine center, in still other embodiments it may be integrated into the machine center itself such as a tool and tool holder stored in a tool carousel associated with the machining center. In some forms, the embodiment may only include a longitudinal compliance structure or feature, while other embodiments may only include an axial compliance structure/feature, and still others may include both a longitudinal compliance structure/feature and an axial compliance structure/feature. In addition to these embodiments, numerous additional methods are also disclosed herein.

Thus, in summary, some examples of the embodiments covered herein include an axial compliance structure (e.g., 426 & 432, 826, 1226) for disengaging a tool (e.g., 420, 820, 1220) from a rotating body (e.g., arbor 1222 or the rotating tool to which it is connected) when a torque threshold has been reached. In FIGS. 12A-I, this includes a first portion 1226f having a first set of teeth on a first side of the first portion 1226f and coupled to the rotating body (e.g., arbor 1222) on a second side of the first portion 1226f, a second portion 1226g having a second set of teeth on a first side of the second portion 1226g for engaging the first set of teeth of the first portion 1226f and coupled to a drive shaft 1228 on a second side of the second portion 1226g for driving a tool (e.g., a socket) via drive shaft 1228, and wherein the first set of teeth and second set of teeth are configured to allow the first portion 1226f to disengage from the second portion 1226g (or vice versa) once a predetermined torque threshold has been reached.

The rotating body may be arbor 1222 or the rotating tool arbor 1222 is connected to, and the tool may be a tool head or bit (such as bit 430) connected to the drive shaft 1228 for performing work on a fastener (e.g., such as fastener 902c in fixture clamp 902). The axial compliance structure may further include a longitudinal compliance structure (e.g., 424, 824, or the combination of 1224, 1228a and 1229a) connected between the tool (e.g., bit 430) and arbor (422, 822, 1222) that allows the drive shaft (1228) to move along its longitudinal axis to keep the bit (e.g., 430) engaged with the fastener (e.g., 902c) as the fastener (902c) moves between an unfastened position and a fastened position.

The longitudinal compliance structure (either on its own or with the axial compliance structure) may include a first arm (1228a) extending from a first side of the drive shaft (1228) and a second arm (1228a) extending from a second side of the drive shaft (1228) opposite the first side having the first arm, and may further include a drive shaft housing (1229) defining a first guide channel (1229a) for receiving at least a portion of the first arm (1228a) on a first side of the drive shaft housing and a second guide channel (1229a) for receiving at least a portion of the second arm (1228a) on a second side of the drive shaft housing (1229) opposite the first side of the drive shaft housing. In one form, the first arm (1228a) has a first bearing (1228d) at least partially disposed in the first guide channel (1229a) and the second arm (1228a) has a second bearing (1228d) at least partially disposed in the second guide channel (1229a), the bearings and guide channels serving to assist the drive shaft (1228) in moving along the longitudinal axis of the drive shaft (1228).

The axial compliance structure may include a torque threshold adjustment mechanism (1226a) for adjusting a torque threshold that causes the axial compliance structure (1226) from disengaging the drive shaft (1228) from the arbor (1222). In one form, the torque threshold adjustment mechanism (1226a) is a rotatable member that rotates with respect to the arbor (1222, and more specifically, 1222b), wherein rotation of the rotatable member (1226a) in a first direction increases the torque threshold required to disengage the axial compliance structure (1226), and rotation of the rotatable member (1226a) in a second direction, different than the first direction, decreases the torque threshold required to disengage the axial compliance structure (1226).

In another form, an embodiment of the inventive concepts disclosed herein may include a tool accessory or feature (1220) offering axial compliance (1226) and longitudinal compliance (1224, 1228a, 1229a) for rotating tools (e.g., such as a spindle from a machine center, a milling machine, a cutting machine, a drill press, etc.). The tool accessory or feature (1220) preferably includes: an arbor (1222) for connecting the tool accessory or feature (1220) to a rotating tool; a drive shaft (1228) aligned with the arbor (1222) and capable of being rotated by the arbor (1222) and ultimately the spindle, with the drive shaft having a longitudinal axis extending therethrough; a longitudinal compliance structure (e.g., 1224, 1228a, 1229a) connected between the arbor (1222) and at least a portion of the drive shaft (1228) and capable of allowing the drive shaft (1228) to move along the longitudinal axis to give the drive shaft (1228) longitudinal compliance; and an axial compliance structure (1226) connected between the arbor (1222) and drive shaft (1228) and capable of allowing the drive shaft (1228) to disengage from the arbor (1222) once a predetermined torque threshold has been reached to provide axial compliance to the tool accessory or feature (1220).

In one form, the longitudinal compliance structure includes a biasing member (such as spring 1224) positioned between the drive shaft (1228) and arbor (1222) for allowing movement of the drive shaft (1228) along the longitudinal axis, and at least one protrusion (1228a) extending from the drive shaft (1228) that engages a channel (1229a) in an adjacent structure (e.g., 1229) for aligning and guiding the at least one protrusion (1228a) to assist the drive shaft (1228) as it moves along the longitudinal access and give the tool accessory or feature (1220) more torque capacity. In the form shown in FIGS. 12A-I, the adjacent structure is drive shaft housing (1229) and the channel comprises a first channel (1229a) on a first side of the drive shaft housing and a second channel (1229a) on a second side of the drive shaft housing, and the at least one protrusion comprises a first protrusion (1228a) extending from a first side of the drive shaft (1228) and into the first channel (1229a) and a second protrusion (1228a) extending from a second side of the drive shaft (1228) and into the second channel (1229a). In a preferred form, the longitudinal compliance structure will also include a first bearing (1228d) positioned on the first protrusion (1228a) of the drive shaft (1228) and at least partially in the first channel (1229a) of the drive shaft housing (1229), and a second bearing (1228d) positioned on the second protrusion (1228a) of the drive shaft (1228) and at least partially in the second channel (1229a) of the drive shaft housing (1229). In an effort to simplify this disclosure we have not tried to create numerous additional reference numerals and lead lines and, thus, reference similar items by similar reference numerals. However, if that is not desired we can assign different reference numbers to these items or add further reference notation (e.g., referencing one with a “i” and the other with a “ii” at the end of the reference numeral merely to distinguish one from the other).

In the form shown in FIGS. 12A-I, the drive shaft housing (1229) has an outer surface and the first and second bearings (1228d) are positioned proximate distal ends of the first and second protrusions (1228a) to provide as large of a moment arm as possible for the tool accessory or feature (1220) within the outer surface of the drive shaft housing (1229) to maximize torque capacity of the tool accessory or feature (1220). In a preferred form, the first and second bearings (1228d) comprise first and second bearing sets (1228d) each having a plurality of bearings disposed within their respective first and second channels (1229a) of the drive shaft housing (1229) and positioning the first and second bearing sets (1228d) proximate the distal end of the first and second protrusions (1228a) respectively to maximize torque capacity of the tool accessory or feature (1220).

The axial compliance structure (1226) will preferably include a first clutch member (1226f) positioned proximate the arbor (1222) and having a mating relationship with the arbor (1222) (e.g., mating male and female configurations such as mortis and tenon, dovetail configurations, pin and recess, etc.; ball and socket configurations; keyed configurations; fastened configurations like threading, hook and loop, etc.), a second clutch member (1226g) positioned proximate the drive shaft (1228) and having a mating relationship with the drive shaft (1228) (e.g., directly or indirectly). In the form illustrated, the mating relationship between second clutch member 1226g and drive shaft 1228 is indirect and by way of drive shaft housing 1229 which has recesses on the surface adjacent second clutch member 1226g (as best seen in FIG. 12I which corresponding mating structures extending from the second clutch member 1226g are disposed in and the fact the drive shaft housing 1229 is axially fixed in position (but not longitudinally) with respect to drive shaft 1228 via drive shaft protrusions 1228a being disposed in channels 1229a of drive shaft housing 1229. All of these structures work together to ensure the second clutch member 1226g rotates with drive shaft 1228 and drive shaft housing 1229. The first and second clutch members (1226a, 1226b respectively) have respective mating teeth for engaging the first and second clutch members (1226a, 1226b) to one another so that rotation of the first clutch member (1226f) moves the second clutch member (1226g) and the mating teeth have a predetermined angle to allow the second clutch member (1226g) to disengage from the first clutch member (1226f) once the predetermined torque threshold has been reached.

In a preferred form, the respective mating teeth of each of the first and second clutch members (1226a, 1226b) have respective leading edges and trailing edges with the leading edges having a first predetermined angle and the trailing edges having a second predetermined angle different than the first predetermined angle so that more torque may be applied to the axial compliance structure (1226) in one rotational direction than may be applied in the opposite rotational direction. For example, in some applications it is desired to allow the drive shaft to experience higher torque when attempting to release a fastener (902c) to overcome the breaking force required to start the loosening process. Thus the trailing edges of the teeth will preferably have a steeper degree angle to allow for this heightened torque to overcome the breaking force required to free the fastener (902c). In other words, the leading teeth edges will be shallower in the tightening direction and deeper in the loosening direction. In many applications, the tightening direction entails clockwise rotation and the loosening direction entails counterclockwise rotation.

In the form illustrated in FIGS. 12A-I, the axial compliance structure (1226) also includes a torque adjustment mechanism (1226a) that biases the second clutch member (1226g) toward the first clutch member (1226f) and exerts more force against the second clutch member (1226g) when torque adjustment mechanism (1226a) is rotated in a first direction (preferably clockwise rotation when looking from the bottom of mechanism 1226a, i.e., looking at it from the side the drive shaft extends from mechanism 1226a) to increase the torque threshold at which the second clutch member (1226g) disengages from the first clutch member (1226f), and less force against the second clutch member (1226g) when rotated in the second direction (preferably counterclockwise rotation) to reduce the torque threshold at which the second clutch member disengages from the first clutch member.

Thus, in the form illustrated, the drive shaft housing 1229 within which at least a portion of the drive shaft 1228 is disposed (e.g., protrusions 1228a) and that works as part of the longitudinal compliance structure (1224, 1228a, 1229a) in assisting the drive shaft (1228) in moving along the longitudinal axis and as part of the axial compliance structure (1226) by assisting the torque adjustment mechanism (1226a) in biasing the second clutch member (1226g) toward the first clutch member (1226f) to exert more force against the second clutch member (1226g) when the torque adjustment mechanism (1226a) is rotated in a first direction to increase the torque threshold at which the second clutch member (1226g) disengages from the first clutch member (1226f), and less force against the second clutch member (1226g) when the torque adjustment mechanism (1226a) is rotated in the second direction to reduce the torque threshold at which the second clutch member (1226g) disengages from the first clutch member (1226f).

As mentioned above, the axial compliance structure (1226) may be integrated into a tool and tool holder to provide a machining tool having the axial compliance structure. In still other forms, the machining tool itself may be part of a larger machine (e.g., a machining center or machine center) such as by being integrated into one of the tools (e.g., tool and tool holder) stored in the integrated carrousel of the machine or machining center. Similarly, it should be noted that numerous methods are disclosed herein such as a method of adding compliance (e.g., 1226, 1224/1228a/1229a) to a tool (e.g., 1220) rotated by an arbor (e.g., 1222) to allow at least one of axial compliance (1226) or longitudinal compliance (1224, 1228a, 1229a) so as to prevent damage (e.g., damage to the tool, the arbor, the rotating spindle tool to which the tool is connected, the drive shaft, the tool to which the drive shaft is connected and/or the fastener being driven by the toll (or any combination or all of the above). In some forms, the method may include adding at least one biasing mechanism (1224, 1226b1) that allows for the tool (1220) to be moved in at least one of an axial or longitudinal compliant manner to add compliance to the tool (1220) and adding a force adjusting mechanism (1226a) capable of adjusting the compliance to move in the at least one of an axial or longitudinal compliant manner. The method may include providing an axial compliance structure (1226) for disengaging the tool (403) or drive shaft (1228) from the arbor (1222) when a torque threshold has been reached, wherein the axial compliance structure includes a first portion (1226f) having a first set of teeth on a first side of the first portion and coupled to the arbor (1222 and in the form shown in FIGS. 12A-I, 1222a) on a second side of the first portion, and a second portion (1226g) having a second set of teeth on a first side of the second portion for engaging the first set of teeth of the first portion and coupled to a drive shaft (1228) (e.g., either directly or indirectly, and in the form shown in FIGS. 12A-I it is indirectly) on a second side of the second portion (1226g) for driving the tool (403). The method may also include configuring the first set of teeth and second set of teeth to allow the first portion (1226f) to disengage from the second portion (1226g) (or vice versa) once a predetermined torque threshold has been reached.

Thus, it is apparent that there has been provided, in accordance with the invention, an improved workpiece securing tool, an improved machine tool (e.g., a machining center tool) and an improved machine (e.g., a machine center) itself, and methods relating to same that fully satisfy the objects, aims and advantages set forth above. While the invention has been described in conjunction with specific embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the appended claims.

What is claimed is:

1. An axial compliance structure for disengaging a tool from a rotating body when a torque threshold has been reached, comprising:
a first portion having a first set of teeth on a first side of the first portion and coupled to the rotating body on a second side of the first portion;
a second portion having a second set of teeth on a first side of the second portion for engaging the first set of teeth of the first portion and coupled to a drive shaft on a second side of the second portion for driving a tool; and
wherein the first set of teeth and second set of teeth are configured to allow the first portion to disengage from the second portion once a predetermined torque threshold has been reached.

2. The axial compliance structure of claim 1 wherein the rotating body is an arbor and the tool is a bit connected to the drive shaft for performing work on a fastener.

3. The axial compliance structure of claim 2 further comprising a longitudinal compliance structure connected between the tool and arbor that allows the drive shaft to move along the longitudinal axis to keep the bit engaged with the fastener as the fastener moves between an unfastened position and a fastened position.

4. The axial compliance structure of claim 3 wherein the longitudinal compliance structure comprises a first arm extending from a first side of the drive shaft and a second arm extending from a second side of the drive shaft opposite the first side having the first arm, and further comprising:
a drive shaft housing defining a first guide channel for receiving at least a portion of the first arm on a first side of the drive shaft housing and a second guide channel for receiving at least a portion of the second arm on a second side of the drive shaft housing opposite the first side of the drive shaft housing.

5. The axial compliance structure of claim 4 wherein the first arm has a first bearing at least partially disposed in the first guide channel and the second arm has a second bearing at least partially disposed in the second guide channel, the bearings and guide channels serving to assist the drive shaft in moving along the longitudinal axis of the drive shaft.

6. The axial compliance structure of claim 5 further comprising a torque threshold adjustment mechanism for adjusting a torque threshold that causes the axial compliance structure from disengaging the drive shaft from the arbor.

7. The axial compliance structure of claim 6 wherein the torque threshold adjustment mechanism is a rotatable member that rotates with respect to the arbor, wherein rotation of the rotatable member in a first direction increases the torque threshold required to disengage the axial compliance structure, and rotation of the rotatable member in a second direction, different than the first direction, decreases the torque threshold required to disengage the axial compliance structure.

8. A machining tool having the axial compliance structure of claim 1.

9. A machine having a machining tool in accordance with claim 8.

10. A method of adding compliance to a tool rotated by an arbor to allow at least one of axial compliance or longitudinal compliance so as to prevent damage, the method comprising:
adding at least one biasing mechanism that allows for the tool to be moved in at least one of an axial or longitudinal compliant manner to add compliance to the tool; and
a force adjusting mechanism capable of adjusting the compliance to move in the at least one of an axial or longitudinal compliant manner.

11. The method of claim 10 comprising providing an axial compliance structure for disengaging the tool from the arbor when a torque threshold has been reached, wherein the axial compliance structure includes a first portion having a first set of teeth on a first side of the first portion and coupled to the arbor on a second side of the first portion, and a second portion having a second set of teeth on a first side of the second portion for engaging the first set of teeth of the first portion and coupled to a drive shaft on a second side of the second portion for driving the tool, and the method further comprises:
configuring the first set of teeth and second set of teeth to allow the first portion to disengage from the second portion once a predetermined torque threshold has been reached.

12. A tool accessory or feature offering axial compliance and longitudinal compliance for rotating tools comprising:
an arbor for connecting the tool accessory or feature to a rotating tool;
a drive shaft aligned with the arbor and capable of being rotated by the arbor, the drive shaft having a longitudinal axis;
a longitudinal compliance structure connected between the arbor and the drive shaft and capable of allowing the drive shaft to move along the longitudinal axis to give the drive shaft longitudinal compliance; and
an axial compliance structure connected between the arbor and drive shaft and capable of allowing the drive shaft to disengage from the arbor once a predetermined torque threshold has been reached to provide axial compliance to the tool accessory or feature.

13. The tool accessory or feature of claim 12 wherein the longitudinal compliance structure comprises:
a biasing member positioned between the drive shaft and arbor for allowing movement of the drive shaft along the longitudinal axis; and
at least one protrusion extending from the drive shaft that engages a channel in an adjacent structure for aligning and guiding the at least one protrusion to assist the drive shaft as it moves along the longitudinal access and give the tool accessory or feature more torque capacity.

14. The tool accessory or feature of claim 13 wherein the adjacent structure is a drive shaft housing and the channel comprises a first channel on a first side of the drive shaft housing and a second channel on a second side of the drive shaft housing, and the at least one protrusion comprises a first protrusion extending from a first side of the drive shaft and into the first channel and a second protrusion extending from a second side of the drive shaft and into the second channel.

15. The tool accessory or feature of claim 14 wherein the longitudinal compliance structure further includes a first bearing positioned on the first protrusion of the drive shaft and at least partially in the first channel of the drive shaft housing, and a second bearing positioned on the second protrusion of the drive shaft and at least partially in the second channel of the drive shaft housing.

16. The tool accessory or feature of claim 15 wherein the drive shaft housing has an outer surface and the first and second bearings are positioned proximate distal ends of the first and second protrusions to provide as large of a moment arm as possible for the tool accessory or feature within the outer surface of the drive shaft housing to maximize torque capacity of the tool accessory or feature.

17. The tool accessory or feature of claim 16 wherein the first and second bearings comprise first and second bearing sets each having a plurality of bearings disposed within their respective first and second channels of the drive shaft housing and positioning the first and second bearing sets proximate the distal end of the first and second protrusions respectively to maximize torque capacity of the tool accessory or feature.

18. The tool accessory or feature of claim 12 wherein the axial compliance structure comprises:
a first clutch member positioned proximate the arbor and having a mating relationship with the arbor;
a second clutch member positioned proximate the drive shaft and having a mating relationship with the drive shaft; and
wherein the first and second clutch members have respective mating teeth for engaging the first and second clutch members to one another so that rotation of the first clutch member moves the second clutch member and the mating teeth have a predetermined angle to allow the second clutch member to disengage from the first clutch member once the predetermined torque threshold has been reached.

19. The tool accessory or feature of claim 18 wherein the respective mating teeth of each of the first and second clutch members have respective leading edges and trailing edges with the leading edges having a first predetermined angle and the trailing edges having a second predetermined angle different than the first predetermined angle so that more torque may be applied to the axial compliance structure in one rotational direction than may be applied in the opposite rotational direction.

20. The tool accessory or feature of claim 18 wherein the axial compliance structure includes a torque adjustment mechanism that biases the second clutch member toward the first clutch member and exerts more force against the second clutch member when rotated in a first direction to increase the torque threshold at which the second clutch member disengages from the first clutch member, and less force against the second clutch member when rotated in the second direction to reduce the torque threshold at which the second clutch member disengages from the first clutch member.

21. The tool accessory or feature of claim 20 comprising a drive shaft housing within which at least a portion of the drive shaft is disposed and that works as part of the longitudinal compliance structure in assisting the drive shaft in moving along the longitudinal axis and as part of the axial compliance structure by assisting the torque adjustment mechanism in biasing the second clutch member toward the first clutch member to exert more force against the second clutch member when the torque adjustment mechanism is rotated in a first direction to increase the torque threshold at which the second clutch member disengages from the first clutch member, and less force against the second clutch member when the torque adjustment mechanism is rotated in the second direction to reduce the torque threshold at which the second clutch member disengages from the first clutch member.
